(19) United States
(12) Patent Application Publication
(10) Pub. No.: US 2004/0112208 A1
(43) Pub. Date: Jun. 17, 2004

(54) Pilot-operated check valve cartridge

(76) Inventor: Norbert J. Kot II, Brookfield, WI (US)

Correspondence Address: RYAN KROMHOLZ & MANION, S.C., POST OFFICE BOX 26618, MILWAUKEE, WI, 53226, US

(21) Appl. No.: 10/248,025

(22) Filed: Dec. 11, 2002

(51) Int. Cl. F15B 11/08

(52) U.S. Cl. 91/420

(57) ABSTRACT

A sleeve carries a check ball valve assembly to form a valve cartridge. The cartridge is insertable into a manifold to communicate with a control valve to extend or retract a piston cylinder in response to pneumatic or hydraulic pressure. The manifold may be contained within a piston end block. The cartridge is selectively removable from the manifold.

### FIELD OF THE INVENTION

The invention relates in general to valve assemblies. In particular, it relates to pilot-operated check valves.

### BACKGROUND OF INVENTION

Systems and devices using pneumatic or hydraulic pressure to drive cylinders are known. These systems and devices typically include pilot-operated check valves that allow the operator to raise or extend the cylinder rod and lock the rod into position. This locking action is the main function of a check valve. When the pressure in the line drops or is completely lost, the valve will hold the cylinder in position until pressure can be reapplied to the system.

Typically, a piston bore, a ball seat bore, and a passageway bore are machined within a valve block. A piston, piston pin, and a piston retainer are then placed within the piston bore. A check valve ball and a ball retainer are then placed within the ball seat bore. The block communicates with a control valve to direct movement of a piston cylinder. The block requires separate ports for connecting air or fluid lines to the valve.

These conventional systems require costly assembly and customized machining. Replacement requires a new block to be machined. Occasionally this requires several jigs or fixtures, further increasing time and cost. The need remains for check valves and check valve assemblies that are compact and that are easy and cost-efficient to manufacture. The need also remains for check valves that can be pre-assembled as a unit for off-the-shelve or catalog sale and that can be readily installed within a variety of different cylinders or other products. Further, the need remains for valve assemblies that can be easily removed to allow repair or replacement.

### SUMMARY OF INVENTION

According to one aspect of the invention, a valve assembly comprises a sleeve and a bore extending through the sleeve. The bore defines a first chamber, a second chamber comprising a ball seat, and a passageway providing communication between the first and second chambers. A check valve ball is sized and configured to be received by the second chamber. The ball has a closed position in which the ball is in abutting contact with the ball seat, and an open position in which the ball is not in abutting contact with the ball seat. An actuator carried by the first chamber. At least a portion of the actuator is advanceable through the passageway to make abutting contact with the ball to move the ball from the closed to the open position. In one embodiment, the actuator comprises a piston and a piston pin.

A first compression mechanism is carried by the first chamber and biases the actuator in a direction outwardly of the first chamber. The actuator is longitudinally advanceable in response to pressure to overcome the bias of the first compression mechanism to longitudinally advance the actuator. A retaining means is provided for retaining the actuator and the first compression mechanism within the first chamber.

A second compression mechanism is carried by the second chamber and biases the ball toward the closed position. The ball is longitudinally advanceable in response to longitudinal advancement of the actuator to overcome the bias of the second compression mechanism to move from the closed to the open position. A retaining means is provided for retaining the ball and second compression mechanism within the second chamber. In one embodiment, the means for retaining the ball provides communication between the second chamber and the outlet end of the sleeve. A manual release pin is provided in abutting relation to the piston.

The assembly is insertable as a unit into a manifold. In one embodiment, the manifold is contained within a piston cylinder.

In one embodiment, the actuator is responsive to air pressure. In an alternative embodiment, the actuator is responsive to hydraulic pressure.

According to another aspect of the invention, a valve assembly comprises a sleeve, and a ball check valve carried by the sleeve to form a valve cartridge. The valve cartridge is insertable as a unit into a manifold. The sleeve comprises at least one ridge to define a plurality of discrete porting chambers when the cartridge is inserted into the manifold.

In one embodiment, the manifold is contained within a piston cylinder. According to another aspect of the invention, the cartridge can be selectively removable from the manifold.

Another aspect of the invention provides a method of directing movement of a piston cylinder. The method comprises providing a sleeve carrying a pneumatic ball check valve assembly to form a valve cartridge, and providing a control valve in communication with the cylinder and the cartridge to control the direction of air flow through the cartridge and the cylinder.

The method further provides for inserting the cartridge as a unit into the manifold, directing air flow through the cartridge in a first direction to extend the cylinder, and directing air flow through the cartridge in a second direction to retract the cylinder. In one embodiment, the manifold is contained within the piston cylinder.

Another aspect of the invention provides a method of directing movement of a piston cylinder. The method comprises providing a sleeve, the sleeve carrying a hydraulic ball check valve assembly to form a valve cartridge, and providing a control valve in communication with the cylinder and the cartridge to control the direction of hydraulic fluid flow through the cartridge and the cylinder.

The method further provides for inserting the cartridge as a unit into the manifold, directing fluid flow through the cartridge in a first direction to extend the cylinder, and directing fluid flow through the cartridge in a second direction to retract the cylinder. In one embodiment, the manifold is contained within the piston cylinder.

### BRIEF DESCRIPTION OF DRAWINGS

FIG. 1 is an exploded section view of a pilot-operated check valve cartridge assembly.

FIG. 2 is an assembled section view of the assembly shown in FIG. 1.

FIG. 3 is a partial section view illustrating placement of the cartridge shown in FIG. 2 within a machined block.

FIG. 4 is a top section view of a valve cartridge and cylinder assembly in which the valve cartridge is inserted into a manifold block and illustrating air flow through the assembly to extend the cylinder.

FIG. 5 is a view similar to FIG. 4 and illustrating air flow through the assembly to retract the cylinder.

FIG. 6 is a top section view of a valve cartridge and cylinder assembly in which the valve cartridge is inserted into the cylinder end cap block and illustrating air flow through the assembly to extend the cylinder.

FIG. 7 is a section view taken along line 7-7 in FIG. 4.

FIG. 8 is a partial section view taken along line 8-8 in FIG. 4.

FIG. 9 is a view similar to FIG. 6 and illustrating air flow through the assembly to retract the cylinder.

FIG. 10 is a section view taken along line 10-10 in FIG. 4.

FIG. 11 is a section view taken along line 11-11 in FIG. 4.

### DETAILED DESCRIPTION

Although the disclosure hereof is detailed and exact to enable those skilled in the art to practice the invention, the physical embodiments herein disclosed merely exemplify the invention that can be embodied in other specific structure. While the preferred embodiment has been described, the details may be changed without departing from the invention, which is defined by the claims.

I. Check Valve Cartridge

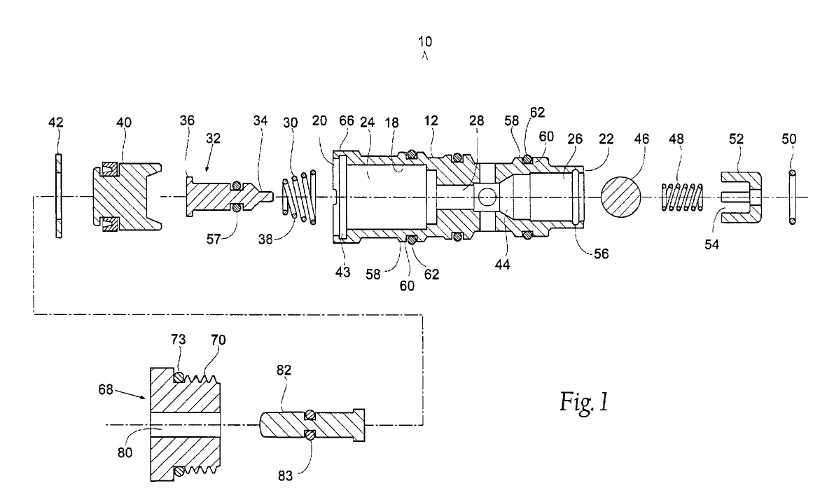

FIGS. 1-3 illustrate a check valve cartridge 10. In one embodiment, the cartridge 10 is adapted for use at standard shop air line pressure of approximately 80-120 psi. It is contemplated, however, that the cartridge 10 can be adapted for use at greater or lesser pneumatic pressure.

The cartridge 10 comprises a generally cylindrical elongated sleeve 12 adapted for placement within a valve bore 14 within a block 16. A longitudinal throughbore 18 having an inlet end 20 and an outlet end 22 extends through the sleeve 12. The throughbore 18 is configured to define a plurality of coaxially-spaced communicating counterbores, including a piston bore 24, a ball seat bore 26, and a passageway bore 28 that provides communication between the piston bore 24 and the ball seat bore 26.

The piston bore 24 is sized and configured to receive a compression mechanism, e.g., a conically wound, helical compression spring 30. The piston bore 24 is further adapted to receive a piston pin 32. The piston pin 32 desirably has a forward end 34 that is sized and configured for passage through the spring 30. The pin 32 preferably includes a head 36 at one end adapted to rest against the constricted end 38 of the spring 30. In this arrangement, the spring 30 normally biases the piston pin 32 in a direction outwardly of the piston bore 24.

A longitudinally-moving piston 40 is sized and configured for abutting contact with the head 36 of the piston pin 32 within the piston bore 24. The piston 40 is longitudinally-advanceable within the bore 24 in response to pressure to overcome the bias of the spring 30 to longitudinally advance the piston pin 32 within the bore 24. Desirably, a C-shaped retaining ring 42 or other suitable retaining mechanism provides for retention of the spring 30, piston pin 32, and piston 40 within the piston bore 24. The ring 42 is preferably sized and configured for engagement with an internal groove 43 formed in the inlet end 20 of the sleeve 12.

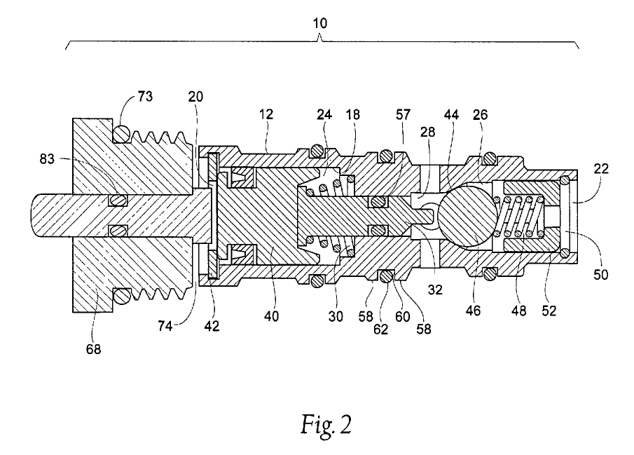

The ball seat bore 26 carries a ball seat 44 and is sized and configured to receive a check valve ball 46. The ball 46 has a seated position in which the ball 46 is in abutting contact with the ball seat 44, forming a ball seal (see, e.g., FIG. 2). When in the closed position, the abutting contact of the ball 46 and the ball seat 44 blocks communication between the passageway 28 and the ball seat bore 26 to essentially block or prevent passage of air from the passageway 28 into the ball seat bore 26.

The ball seat bore 26 is desirably also sized and configured to receive a compression mechanism, e.g., a helically wound compression spring 48. The compression spring 48 normally biases the ball 46 toward the seated or closed position within the ball seat bore 26.

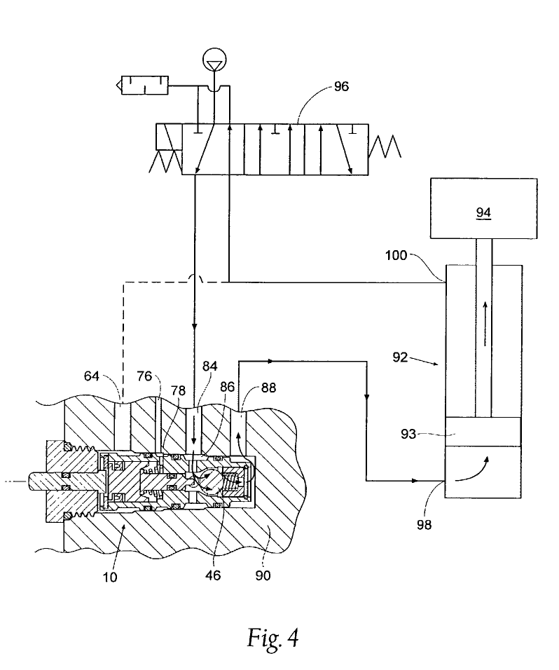

The ball 46 also has an open position in which the ball 46 is not in contact with the ball seat 44 (see, e.g., FIG. 4). In the open position, the ball 46 does not block communication between the passageway 28 and the ball seat bore 26 and thereby permits passage of air from the passageway 28 into the ball seat bore 26.

In this arrangement, the ball 46 can be longitudinally advanceable in response to longitudinal advancement of the piston pin 32 to overcome the bias of the compression spring 48. In a preferred embodiment, a retaining mechanism provides for retention of the ball 46 and spring 48 within the ball seat bore 26. In the illustrated embodiment, the retaining mechanism takes the form of a C-shaped retaining ring 50 and a cup-like ball retainer 52 having one or more apertures 54. It should be understood that the number and placement of apertures 54 could vary. The retaining ring 50 is sized and configured for engagement with an internal groove 56 formed in the outlet end 22 of the sleeve 12. This arrangement permits air to flow out from the ball seat bore 26 through the apertures 54 and the retaining ring 50.

In response to longitudinal advancement of the piston 40 within the piston bore 24, the piston pin 32 advances through the passageway 28 to make abutting contact with the seated ball 46. The abutting contact places pressure on the ball 46 to overcome the bias of the spring 48 and move the ball seal to the open position. The piston pin 32 can include a conventional O-ring 57 or other suitable sealing element to prevent leakage or backflow of air from the passageway 28 to the piston bore 24 when the piston pin 32 is advanced into the passageway 28.

The sleeve can comprise a plurality of radially-extending, axially-spaced ridges 58. Each pair of ridges 58 defines a groove 60 that is sized and configured to receive an annular sealing ring, e.g., a conventional O-ring 62. It should be understood that the number and placement of ridges 58 and grooves 60 could vary.

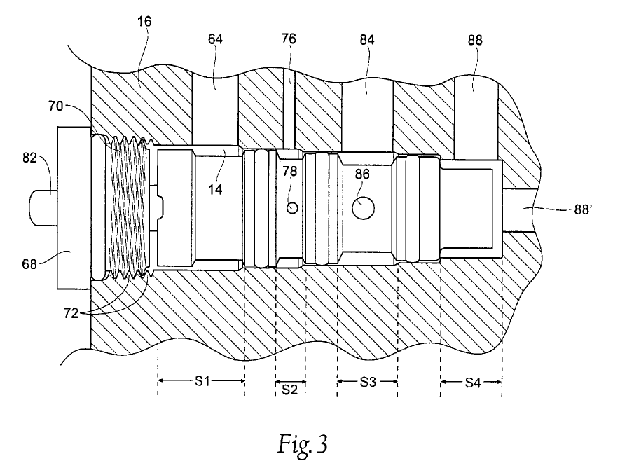

In the illustrated embodiment, three pair of ridges 58 divide the sleeve 1 2 in four sections (S1-S4, inclusive) of reducing diameter, such that S1 diameter>S2 diameter>S3 diameter>S4 diameter. This arrangement allows for ease of placement of the sleeve 12 within a valve bore 14. Each section S1-S4 defines a porting chamber. As best seen in FIG. 3, the valve bore 14 is sized and configured to provide frictional engagement with the sealing rings 62 and thereby seal chambers S1-S4 so as to prevent communication between chambers S1-S4.

The porting chamber defined by S1 permits communication between the piston bore 24 and a pilot port 64. S1 can also comprise a flanged collar 66.

In the illustrated embodiment, an end cap 68 forms the end region of the valve bore 14 to seal the cartridge 10 within the block or manifold 16. Exterior threads 70 on the end cap 68 mate with interior threads 72 in the valve bore 14 to permit removal of the end cap 68 from the block 16. With the end cap 68 removed, the cartridge 10 can be easily removed and replaced. The end cap 68 can include a conventional O-ring 73 or other suitable sealing element to prevent leakage of air about the cap 68 when screwed into the block 16. The end cap 68 is desirably positioned within the block 16 to provide a slight gap 74 between the collar 66 and the end cap 68. In this arrangement, the gap 74 permits air to pass from the pilot port 64 under the end cap 68 into the piston bore 24.

The porting chamber defined by S2 communicates with a venting port 76. In this arrangement, the sleeve 12 in the S2 region comprises at least one vent aperture 78. It should be understood that the number and size of the vent apertures 78 could vary. In a representative embodiment, one vent aperture 78 is provided. The vent aperture (s) 78 need not be in alignment with the venting port 76. It is only necessary that the S2 region be aligned with the venting port 76 to provide communication between the vent aperture 78 and the venting port 76.

The end cap 68 can comprise a throughbore 80 for receiving a manual release pin 82. The release pin 82 extends through the throughbore 80 of the end cap 68 to abut against the piston 40. In this arrangement, manual pressure on the release pin 82 by an operator serves to advance the piston 40 and the piston pin 32 to move the ball 46 from the closed to the open position and thereby release trapped air through the vent aperture 78 and venting port 76. The release pin 82 can include a conventional O-ring 83 or other suitable sealing element to prevent leakage of air when inserted into the end cap 68.

The vent aperture 78 and venting port 76 allow release of compressed air between the piston 40 and the piston pin 32. Thus, the vent aperture 78 and venting port 76 are desirably provided to ensure optimal performance of the cartridge. However, this compressed air does not significantly affect the function of the cartridge 10 if the parts are small. Therefore, the vent aperture 78 can be removed from designs where the piston diameter is small, resulting in reduced manufacturing costs and eliminating passages for debris to collect. It has been found that the vent aperture 78 can be omitted in designs having a piston 40 diameter less than approximately 0.312 inch and suitable function can still be maintained. It should be understood that as piston 40 diameter increases, omission of the vent aperture 78 begins to compromise the efficiency of the device. Eventually, the piston 40 diameter reaches a point above which a vent aperture 78 is required to maintain suitable function.

The porting chamber defined by S3 provides communication between the passageway 28 and an input port 84. In this arrangement, the sleeve 12 in the S3 region comprises at least one input aperture 86. It should be understood that the number and size of input apertures 86 could vary. In a representative embodiment, four input apertures 86 of uniform size are equally spaced around the circumferential margin of the sleeve 12 in the S3 region. The input aperture(s) 86 need not be in alignment with the input port 84. It is only necessary that the S3 region be aligned with the input port 84.

The porting chamber defined by the S4 region provides communication between the ball seat bore 26 and an output port 88 or 88″. Air exits the cartridge 10 through the outlet end 22 of the sleeve 12 and is directed by the porting chamber into the outlet port 88.

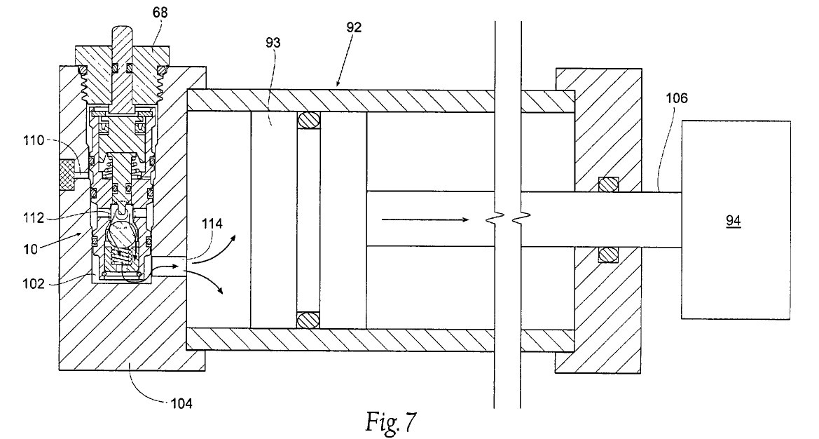

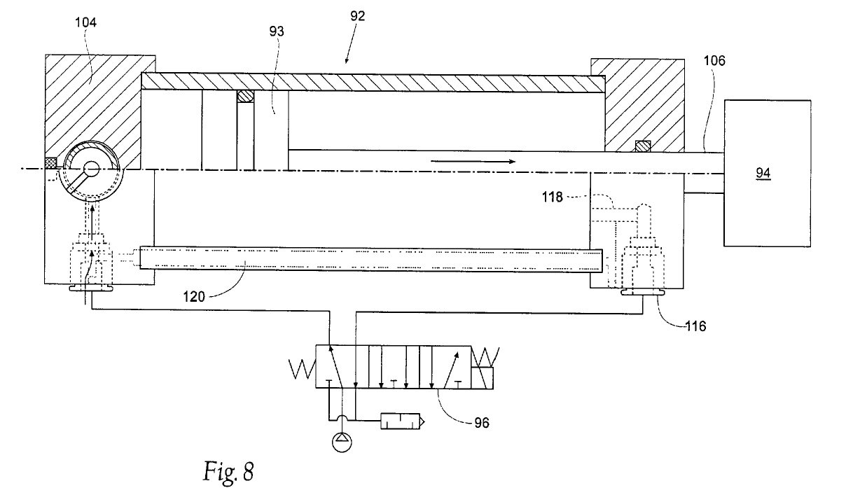

The separate components of the cartridge 10 can be easily pre-assembled for sale as a unit. The small, compact size of the cartridge 10 makes it suitable for use with a variety of different products. In one embodiment, illustrated in FIGS. 3-8, the cartridge 10 is inserted directly into a product, e.g., machined manifold 90. Any number of different valve assemblies can be assembled to form an entire circuit within the manifold block 90. Since the valve assembly does not have to be machined into the manifold 90, the cartridge 10 allows the product into which it is installed to be of a smaller and less expensive design.

The cartridge 10 design offers significant advantages. It is often less expensive for a manufacturer to design the cartridge 10 directly into their equipment. The overall design package is easier to install, smaller, and more aesthetically appealing because the design requires less connectors and external plumbing. Repair is as simple as removing the cartridge 10 and inserting a new cartridge 10.

FIG. 4 illustrates air flow through the valve cartridge 10 to extend a cylinder 92 comprising a conventional piston 93 and carrying a load 94. The direction of air flow is represented by arrows. The system desirably includes a proportioning valve 96 of the type known in the art to control the direction of air flow through the cylinder 92. The control valve 96 is attached in such a manner so as to extend and retract the cylinder 92.

To extend the cylinder 92, air is applied to the input port 84 of the manifold 90. The pressure moves the ball 46 from the closed to the open position. Air then flows through the output port 88 and through an advance port 98 in the cylinder 92. The cylinder 92 will extend and stay locked until air pressure is applied to retract the cylinder 92.

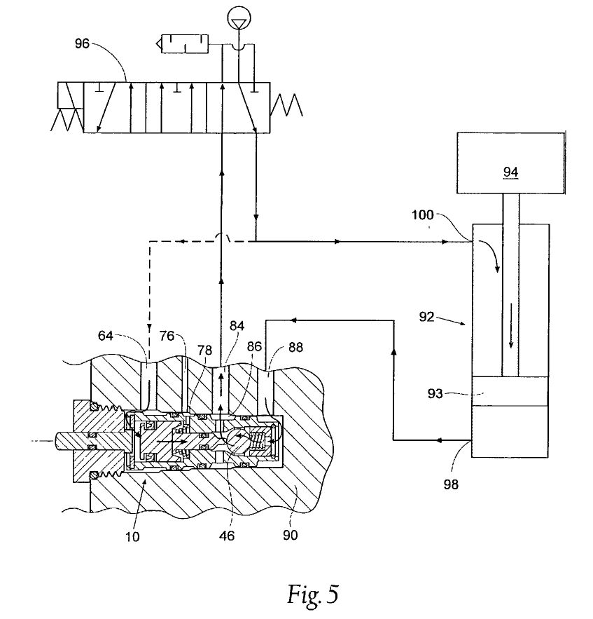

FIG. 5 illustrates air flow through the cartridge 10 to retract the cylinder 92, with arrows representing the direction of air flow. To retract the cylinder 92, air pressure is applied to a retract port 100 in the cylinder 92 and to the pilot port 64 in the manifold 90. Pressure applied to the pilot port 64 pushes the piston 40 and piston pin 32 forward to open the ball seal. Air can then escape from the cylinder 92 by passing through the advance port 98 and past output port 88, out the input port 84, and through the control valve 96 to the atmosphere.

To manually release trapped air, the manual release 82 can be activated.

II. Alternative Embodiment

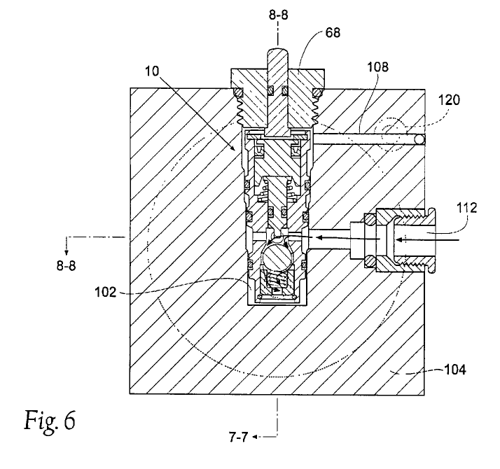

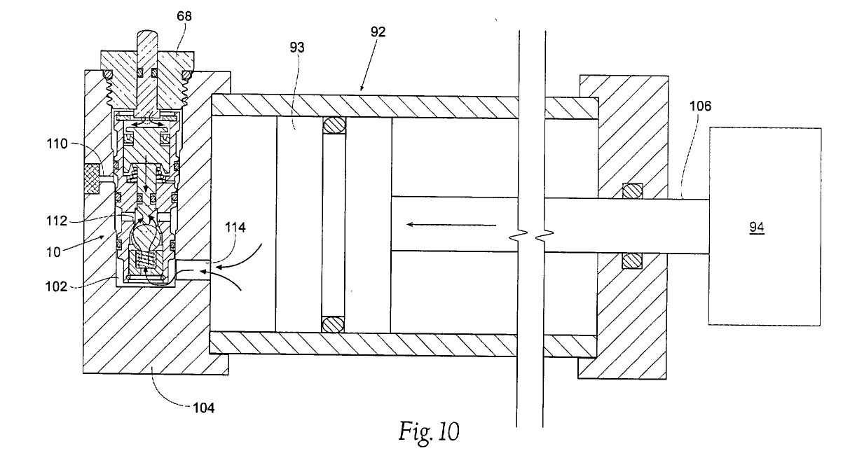

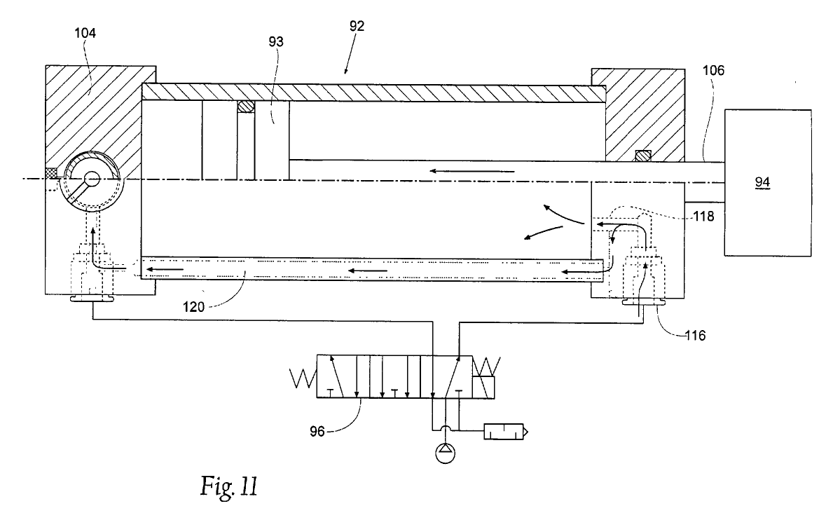

The cartridge 10 can be installed in a variety of products. With reference to FIGS. 6-11, it will be observed that an alternative embodiment utilizes a cartridge 10 installed in a bore 102 machined in a block or end cap 104 of a cylinder 92 carrying a load 94. The embodiment is similar to the embodiment shown in FIGS. 4-9, and like reference numbers denote like parts. In the illustrated embodiment, the cartridge 10 is inserted in the cylinder end cap 104 opposite the rod end 106 of the cylinder 92. The end cap 68 seals the cartridge 10 within the bore 102. It is to be understood that the cartridge 10 can be inserted into either end of the cylinder 92. Alternatively, a cartridge 10 can be inserted into each end of a cylinder 92.

In this arrangement, the porting chamber defined by S1 communicates with a passage 108. The passage 108 is similar in function to pilot port 64. The porting chamber defined by S2 communicates with a venting port 110. The venting port 110 is similar in function to venting port 76. The porting chamber defined by S3 communicates with a port 112. The port 112 is similar in function to input port 84. The porting chamber defined by S4 communicates with a passage 114. The passage 114 is similar in function to output port 88.

FIGS. 6-8 illustrate air flow through the valve cartridge 10 to extend the cylinder 92. The direction of air flow is represented by arrows. To extend the cylinder 92, air pressure is applied to port 112, where the ball seal is opened and air pressure is applied to the cylinder piston 93 through a passage 114. The cylinder 92 will extend and stay locked until air pressure is applied to retract the cylinder 92.

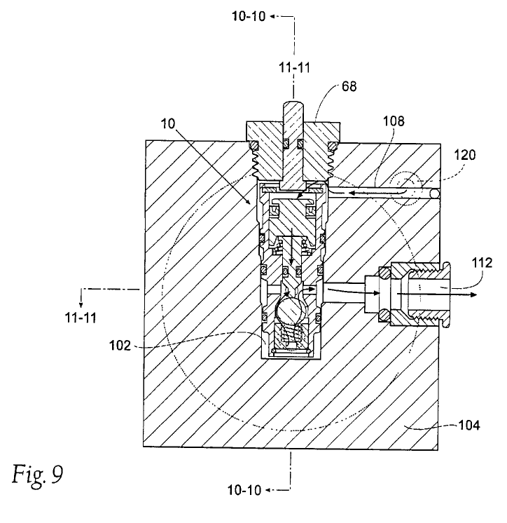

FIGS. 9-11 illustrate air flow through the valve cartridge 10 to retract the cylinder 92, with the direction of air flow being represented by arrows. To retract the cylinder 92, air is applied to port 116, where air can retract the cylinder 92 by moving through passage 118 to apply force to the cylinder piston 93. At the same time, air travels through a cross tube 120, where air pressure is applied to the piston 40 through passage 108. The piston 40, in turn, applies force to the piston pin 32, causing the piston pin 32 to advance and open the ball seal. Air pressure that is forced out of the cylinder 92 can now move through passage 114, through the ball seat bore 26, and out port 112. The control valve 96 is in a vent position, so the air is vented to the atmosphere.

To manually release trapped air, the manual release 82 can be activated.

While this specification describes the cartridge 10 generally in relation to pneumatic systems, it should be appreciated that the cartridge 10 can also be adapted for use in hydraulic systems. In a representative embodiment, the cartridge 10 can be adapted for use at up to approximately 5,000 psi.

Slmilar to the use of pneumatic pressure to direct air flow as previously described, hydraulic pressure can be used to direct fluid flow through the cartridge 10 to extend and retract a cylinder 92.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A valve assembly comprising
a sleeve;
a bore extending through the sleeve, the bore defining a first chamber, a second chambeThe foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.r comprising a ball seat, and a passageway providing communication between the first and second chambers, a check valve ball sized and configured to be received by the second chamber and having a closed position in which the ball is in abutting contact with the ball seat, and an open position in which the ball is not in abutting contact with the ball seat,
an actuator carried by the first chamber, at least a portion of the actuator being advanceable through the passageway to make abutting contact with the ball to move the ball from the closed to the open position.

2. A valve assembly as in claim 1
wherein the sleeve includes a venting aperture adapted to provide communication between the passageway and a venting port.

3. A valve assembly as in claim 1
wherein the sleeve includes an input aperture adapted to provide communication between the passageway and an input port.

4. A valve assembly as in claim 1
wherein the actuator comprises a piston and
a piston pin.

5. A valve assembly as in claim 4
wherein the piston has a diameter of less than approximately 0.312 inch.

6. A valve assembly as in claim 5
wherein the sleeve does not include a venting aperture.

7. An assembly as in claim 1, further comprising
a first compression mechanism carried by the first chamber and biasing the actuator in a direction outwardly of the first chamber, the actuator being longitudinally advanceable in response to pressure to overcome the bias of the first compression mechanism to longitudinally advance the actuator.

8. An assembly as in claim 7, further comprising
means for retaining the actuator and the first compression mechanism within the first chamber.

9. An assembly as in claim 1, further comprising
a second compression mechanism carried by the second chamber and biasing the ball toward the closed position, the ball being longitudinally advanceable in response to longitudinal advancement of the actuator to overcome the bias of the second compression mechanism to move from the closed to the open position.

10. An assembly as in claim 1, further comprising
means for retaining the ball and the second compression mechanism within the second chamber.

11. An assembly as in claim 10
wherein the means for retaining provides communication between the second chamber and the outlet end of the sleeve.

12. An assembly as in claim 1, further comprising
a manual release pin in abutting relation to the piston.

13. An assembly as in claim 1
wherein the assembly is insertable as a unit into a manifold.

14. An assembly as in claim 13
wherein the manifold is contained within a piston cylinder.

15. An assembly as in claim 1
wherein the actuator is responsive to air pressure.

16. An assembly as in claim 1
wherein the air pressure is in the range of 80-120 psi.

17. An assembly as in claim 1
wherein the actuator is responsive to hydraulic pressure.

18. A valve assembly comprising
a sleeve, and
a ball check valve carried by the sleeve to form a valve cartridge, the valve cartridge being insertable as a unit into a manifold,
the sleeve comprising at least one ridge to define a plurality of discrete porting chambers when the cartridge is inserted into the manifold.

19. An assembly as in claim 18
wherein at least one of the porting chambers provides communication with a pilot port in the manifold.

20. An assembly as in claim 18
wherein at least one of the porting chambers provides communication with a venting port in the manifold.

21. An assembly as in claim 18
wherein at least one of the porting chambers provides communication with an input port in the manifold.

22. An assembly as in claim 18
wherein at least one of the porting chambers provides communication with an output port in the manifold.

23. An assembly as in claim 18
wherein the manifold is contained within a piston cylinder.

24. An assembly as in claim 18
wherein the cartridge is selectively removable from the manifold.

25. A method of directing movement of a piston cylinder comprising
providing a sleeve, the sleeve carrying a pneumatic ball check valve assembly to form a valve cartridge,
providing a control valve, the control valve being in communication with the cylinder and the cartridge to control the direction of air flow through the cartridge and the cylinder,
inserting the cartridge as a unit into the manifold,
directing air flow through the cartridge in a first direction to extend the cylinder, and
directing air flow through the cartridge in a second direction to retract the cylinder.

26. A method as in claim 25
wherein the manifold is contained within the piston cylinder.

27. A method of directing movement of a piston cylinder comprising
providing a sleeve, the sleeve carrying a hydraulic ball check valve assembly to form a valve cartridge,
providing a control valve, the control valve being in communication with the cylinder and the cartridge to control the direction of air flow through the cartridge and the cylinder,
inserting the cartridge as a unit into the manifold,
directing fluid flow through the cartridge in a first direction to extend the cylinder, and
directing fluid flow through the cartridge in a second direction to retract the cylinder.

28. A method as in claim 27
wherein the manifold is contained within the piston cylinder.
